(19) United States
(12) Patent Application Publication
(10) Pub. No.: US 2026/0010961 A1
(43) Pub. Date: Jan. 8, 2026

(54) AUTOMATIC NATURAL LANGUAGE CONSTRUCTION MONITORING

(71) Applicant: VERIROOF LLC, Ft Worth, TX (US)

(72) Inventors: Charles Nelson, Midland, TX (US); Walter Storm, Ft Worth, TX (US); Melva Storm, Ft Worth, TX (US); Krag Browder, North Richland Hills, TX (US); Matthew Landowski, Aledo, TX (US)

(73) Assignee: VERIROOF LLC, Ft Worth, TX (US)

(21) Appl. No.: 19/255,392

(22) Filed: Jun. 30, 2025

Related U.S. Application Data
(60) Provisional application No. 63/666,925, filed on Jul. 2, 2024.

(51) Int. Cl. G06Q 50/08; G06F 16/29; G06Q 30/018

(52) U.S. Cl. CPC G06Q 50/08; G06F 16/29; G06Q 30/018

(57) ABSTRACT

Apparatus and associated methods relate to a visual quality analysis engine (VQAE) configured to monitor construction projects and/or ensure compliance with predetermined quality standards. In an illustrative example, the VQAE may monitor roofing projects based on job information (e.g., jobsite location, job scope, quality standards) from an enterprise resource management (ERM) system. The VQAE may, for example, receive images documenting the completion of a construction step from a user device. The VQAE may select predetermined natural language questions (PNLQs) from a data store corresponding to the construction step. By applying the PNLQs to multi-modal large language models (LLMs), the VQAE may receive (binary) answers based on the images and the job metadata. In some implementations, the VQAE may generate a binary classification vector as a response to the received images. Various embodiments may advantageously provide faster response times and simplicity in processing by generating single-stage inferences.

### CROSS-REFERENCE TO RELATED APPLICATIONS

This application is a non-provisional application and claims the benefit of U.S. Application Ser. No. 63/666,925, titled “AUTOMATIC NATURAL LANGUAGE CONSTRUCTION MONITORING,” filed by Charles Nelson et al., on Jul. 2, 2024.

This application incorporates the entire contents of the foregoing application(s) herein by reference.

### TECHNICAL FIELD

Various embodiments relate generally to automated systems for remote monitoring and verifying work.

### BACKGROUND

Construction is an industry that shapes the built environment, encompassing the planning, design, and building of infrastructure, residential, commercial, and industrial structures. It integrates a wide range of disciplines including architecture, civil engineering, project management, and skilled labor. Construction projects come in various forms and are tailored to meet functional and structural preferences.

Common types include residential developments such as homes and apartment complexes; commercial buildings like offices, shopping centers, and hotels; and large-scale infrastructure projects such as bridges, highways, and airports. Industrial construction, including factories and power plants, have specialized engineering and regulatory compliance. Modular and prefabricated construction methods are also gaining popularity due to their ability to reduce timelines and improve consistency in project delivery.

Quality systems in construction may, for example, ensure that construction projects meet standards, regulations, and client expectations. These systems encompass formal processes for quality planning, assurance, and control throughout the project lifecycle.

### SUMMARY

Apparatus and associated methods relate to a visual quality analysis engine (VQAE) configured to monitor construction projects and/or ensure compliance with predetermined quality standards. In an illustrative example, the VQAE may monitor roofing projects based on job information (e.g., jobsite location, job scope, quality standards) from an enterprise resource management (ERM) system. The VQAE may, for example, receive images documenting the completion of a construction step from a user device. The VQAE may select predetermined natural language questions (PNLQs) from a data store corresponding to the construction step. By applying the PNLQs to multi-modal large language models (LLMs), the VQAE may receive (binary) answers based on the images and the job metadata. In some implementations, the VQAE may generate a binary classification vector as a response to the received images. Various embodiments may advantageously provide faster response times and simplicity in processing by generating single-stage inferences.

Various embodiments may achieve one or more advantages. For example, some embodiments may advantageously define the quality of the construction process by applying natural language questions directly to the image data from the job site. Some embodiments, for example, may advantageously verify geolocation of the images to match the job site location. For example, some embodiment may advantageously generate a notification of justification of disapproval (e.g., any improperly installed component, any defects). Some embodiments, for example, may advantageously generate a contractor scoring based on a historical record of quality.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary automatic natural language monitoring system (ANLMS) employed in an illustrative use-case scenario.

FIG. 2 is a block diagram depicting an exemplary automatic work inspection device (AWID).

FIG. 3 is a flowchart illustrating an exemplary automatic natural language monitoring method.

FIG. 4 is a flowchart illustrating an exemplary ANLMS configuration method.

Like reference symbols in the various drawings indicate like elements.

### DETAILED DESCRIPTION OF ILLUSTRATIVE EMBODIMENTS

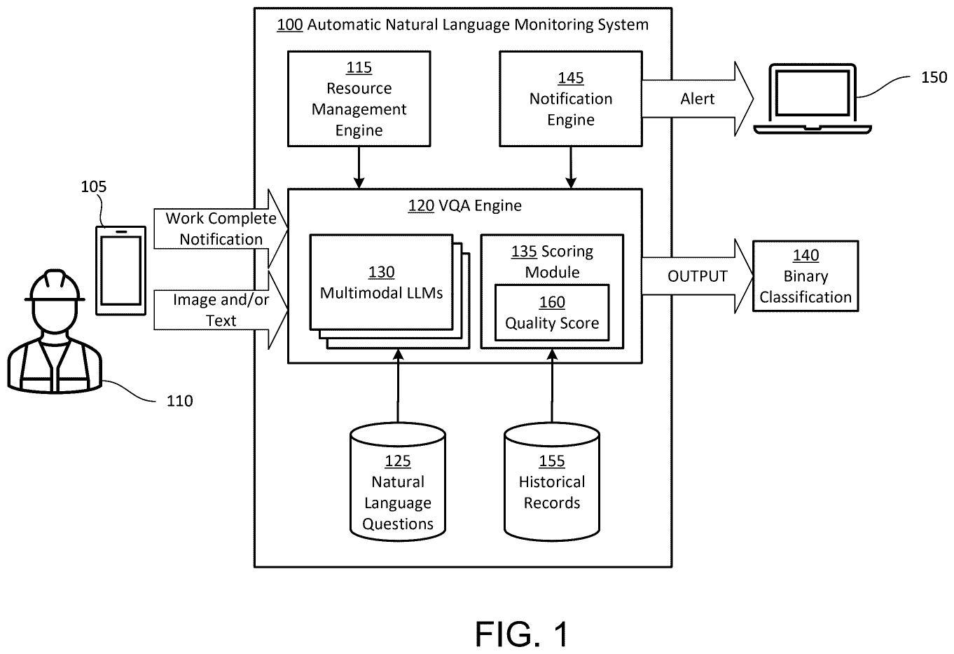

FIG. 1 depicts an exemplary automatic natural language monitoring system (ANLMS 100) employed in an illustrative use-case scenario. For example, the ANLMS 100 may monitor roofing projects to determine whether predetermined steps are completed according to predetermined quality standards (e.g., International Residential Code).

As shown, the ANLMS 100 is operably connected to a user device 105 on a jobsite. For example, the user device 105 may be operated by a worker 110 of the jobsite. For example, the job site may include various construction areas (e.g., the roof, interior, exterior sections of a building). The user device 105, for example, may be configured to capture step completion images (e.g., for documenting the completion of construction steps). In some implementations, the ANLMS 100 may receive a work complete notification and the step completion images from the user device 105.

In this example, the ANLMS 100 includes a resource management engine 115. For example, the resource management engine 115 may include an enterprise resource management (ERM) system. For example, the resource management engine 115 may be configured to generate job metadata (e.g., information) of the jobsite. For example, the job metadata may include a detailed description of the work to be performed. For example, the job metadata may include jobsite location, job scope, and other metadata related to the job.

As shown, the ANLMS 100 includes a visual quality analysis engine (VQAE 120) coupled to the resource management engine 115. The VQAE 120, for example, may receive job information from an enterprise resource management (ERM) system. In some implementations, the VQAE 120 may automatically approve a work completion request received from the user device 105.

As an illustrative example, the VQAE 120 may receive from the user device 105 on the jobsite an indication that a predefined step in a predetermined construction process (e.g., as indicated in the job metadata) has been completed. For example, the VQAE 120 may receive from the worker 110 one or more images documenting the completion of the construction step.

As shown, the VQAE 120 is coupled to a natural language questions repository (NLQR 125). For example, in response to an image received from the user device 105, the VQAE 120 may select, from the NLQR 125, a predetermined natural language question corresponding to completion of the step represented by the received image. In some examples, the VQAE 120 may automatically determine the represented step by inquiring the resource management engine 115 about the current step of the construction process performed by the worker 110. In some implementations, the VQAE 120 may generate an answer to the predetermined natural language question based on the images provided by the user device 105, and the job metadata associated with the user device 105 received from the resource management engine 115.

In this example, the VQAE 120 includes multimodal LLMs 130 and a scoring module 135. For example, the multimodal LLMs 130 may be proprietary and/or external (e.g., publicly available) models. For example, the VQAE 120 may apply the multimodal LLMs 130 to the images and/or the job metadata received from the resource management engine 115 to answer the predetermined natural language question retrieved from the NLQR 125. In some implementations, the VQAE 120 may generate a binary classification vector 140 as a response to the predetermined natural language question. For example, the binary classification vector 140 may include a binary answer (e.g., a yes or no, a 0 or 1, −1 or +1). For example, the binary classification vector 140 may indicate whether the construction step under analysis meets a predetermined quality standard (e.g., the IRC).

In some implementations, the binary classification vector 140 includes two possible values: TRUE or FALSE. A TRUE value, for example, may indicate that the construction step complies with the standards (e.g., “Yes, the old roof was removed down to the deck”). For example, a FALSE value may indicate non-compliance (e.g., “No, roofing underlayment is still present”). For example, the binary classification vector 140 may advantageously provide a clear and concise assessment of the construction step. For example, the binary classification vector 140 may allow a clear communication of the construction quality status.

As an illustrative example, the worker 110 may be working on a roofing job. For example, after a removal step, the VQAE 120 may receive from the user device 105 images documenting completion of removal of the old roof. In some examples, the VQAE 120 may retrieve a natural language question asking, “Was the old roof removed down to the deck?” For example, the VQAE 120 may determine, based on a geolocation of the image and the job metadata received from the resource management engine 115, whether the images were taken at the jobsite. For example, the VQAE 120 may determine, based on the images, whether an answer to the natural language question is TRUE (e.g., yes, the old roof was removed down to the deck) or FALSE (e.g., no, roofing underlayment is seen in the pictures).

In some implementations, the VQAE 120 may generate reasons for the binary classification vector 140. For example, the multimodal LLMs 130 may generate a natural language justification. For example, the binary classification vector 140 may include, in addition to the binary answer, a reason for disapproval (e.g., “roofing felt is visible in the images”).

In some implementations, the predetermined natural language questions may each correspond to at least one predetermined job completion step. For example, a first question may correspond to removal of the old roof down to the deck. A second question may correspond to an installation of a valley liner. A third question may correspond to an installation of new underlayment. A fourth question may correspond to an installation of roofing. The questions may, for example, correspond to requirements of building codes.

In some examples, the multimodal LLMs 130 may include a transformer architecture. For example, the multimodal LLMs 130 may include an advanced neural network design to analyze images and textual data.

In some implementations, the ANLMS 100 may include a notification engine 145 configured to generate a single-stage inference. The single-stage inference may, for example, provide faster response and/or simplicity in processing. In some embodiments, upon receiving a the inference from the multimodal LLMs 130 about a completion request, the VQAE 120 may trigger the notification engine 145 to generate a notification to a reviewer device 150 (e.g., foreman, contractor, real estate owner).

For example, if the VQAE 120 determines a stage was completed successfully, a notification of successful completion may be sent to the reviewer device 150. For example, if the VQAE 120 determines a stage failed, an alert may be sent. In some examples, the VQAE 120 may provide a signal back to the resource management engine 115 indicating a job status.

In some embodiments, the visual quality analysis engine may be coupled to a historic records 155 for the worker 110. Based on historic results stored in the historic records 155, the scoring module 135 may generate a quality score 160 for the worker 110.

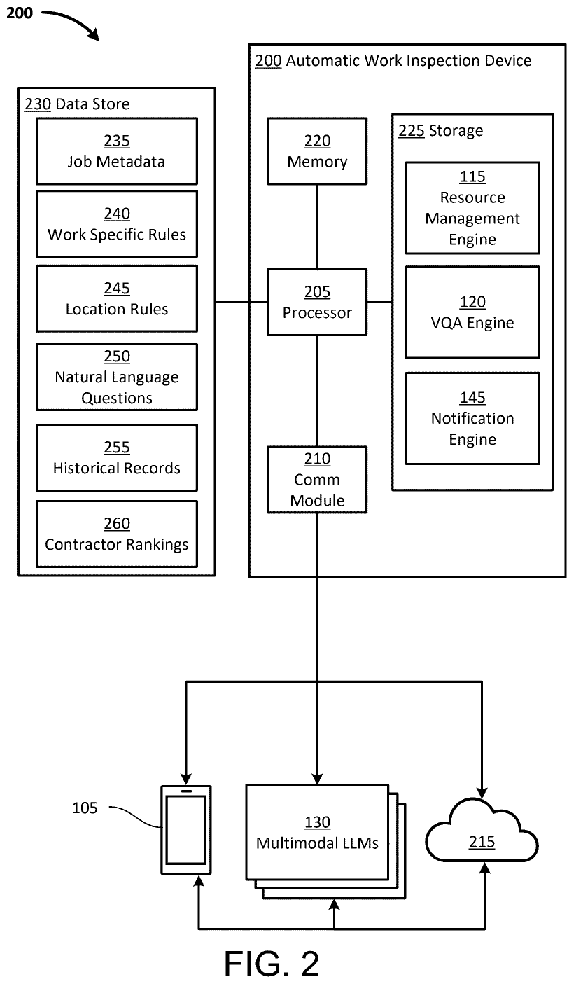

FIG. 2 is a block diagram depicting an exemplary automatic work inspection device (AWID 200). For example, the ANLMS 100 described in FIG. 1 may include the AWID 200. In this example, the exemplary AWID 200 includes a processor 205. The processor 205 may, for example, include one or more processing units. The processor 205 is operably coupled to a communication module 210. The communication module 210 may, for example, include wired communication. The communication module 210 may, for example, include wireless communication. In the depicted example, the communication module 210 is operably coupled to a communication network 215, the multimodal LLMs 130, and the user device 105. For example, the communication module 210 may include a cellular communication module to connect to the user device 105. In some implementations, the communication module 210 may communicate with the user device 105 via the communication network 215. For example, the communication network 215 may include the Internet. For example, the communication module 210 may be configured to communicate with the multimodal LLMs 130 via the communication network 215. In some implementations, the AWID 200 may transmit the alert to the reviewer device 150 through the communication network 215.

The processor 205 is operably coupled to a memory module 220. The memory module 220 may, for example, include one or more memory modules (e.g., random-access memory (RAM)). The processor 205 includes a storage module 225. The storage module 225 may, for example, include one or more storage modules (e.g., non-volatile memory). In the depicted example, the storage module 225 includes the resource management engine 115, the VQAE 120, and the notification engine 145.

The processor 205 is further operably coupled to a data store 230. The data store 230 includes job metadata 235, work specific rules 240, and location rules 245. For example, the job metadata 235, the work specific rules 240, and the location rules 245 may be generated by the resource management engine 115. In some embodiments, the resource management engine 115 may, upon a job is initiated (e.g., by a user such as a salesperson), the resource management engine 115 may generate the job metadata 235, the work specific rules 240, and the location rules 245 based on information related to the job. In some implementations, the job metadata 235, the work specific rules 240, and the location rules 245 may be updated by the AWID 200 (e.g., the resource management engine 115, the VQAE 120) based on a current progress of the job. For example, the job metadata 235 may include a current work phase of a roofing job. The current work phase, for example, may be a roof removal phase, indicating a roof to be removed at this stage of the job. After the roof is removed and confirmed by the VQAE 120, the resource management engine 115 may update the current work phase to, for example, a valley liner installation phase. Various embodiments may advantageously allow the VQAE 120 to select appropriate questions to be applied to the multimodal LLMs 130 to generate the binary classification vector 140.

For example, the job metadata 235 may include geolocations of a job. For example, the job metadata 235 may include job details (e.g., dimensions, materials used and/or removed, a required quality standard such as, for example, high, medium, standards). In some implementations, the job metadata 235 may be stored as a data object. For example, the job metadata 235 may be stored in a structured format. For example, the job metadata 235 may be stored as a relational database (e.g., MySQL, PostgreSQL, Oracle Database, Microsoft SQL Server). For example, the job metadata 235 may be stored as a NoSQL database (e.g., MongoDB, Redis, Apache Cassandra, Neo4j). For example, the job metadata 235 may be stored in data interchange formats (e.g., JSON (JavaScript Object Notation), XML (extensible Markup Language).

In some examples, the work specific rules 240 may include criteria and standards (e.g., the IRC) that each construction step must meet. In some implementations, the resource management engine 115 may generate the work specific rules 240 based on the job metadata 235. For example, based on the job metadata 235, the resource management engine 115 may retrieve industry standards and/or may meet requirements for different phases of the job (e.g., construction process) to be completed.

The location rules 245, for example, may include various rules for verifying a geolocations of the user device 105. For example, the location rules 245 may include coordinates of a location related to the job. In some embodiments, the location rules 245 may include network equipment information for routing the work completion signals and the image data from the user device 105.

The data store 230 also includes natural language questions 250. For example, the natural language questions 250 may include predetermined questions related to (e.g., preconfigured for) each construction step that need to be verified for quality and compliance. The natural language questions 250 may be retrieved and used by the visual quality analysis engine (VQAE 120) to generate and assess inputs from the user device 105. For example, the VQAE 120 may generate the binary classification vector 140 by selecting and applying the natural language questions 250 to the multimodal LLMs 130 based on the images and metadata received from the user device 105.

In some implementations, the VQAE 120 may select one or more questions from the natural language questions 250 based on the job metadata 235, the work specific rules 240, and the location rules 245. As an illustrative example, the VQAE 120 may determine a current phase of the construction process from the job metadata 235. Based on the current phase, the VQAE 120 may select a relevant question(s) corresponding to this phase. If the job metadata 235 indicates, as an illustrative example without limitation, that the current step involves the installation of roofing underlayment, for example, the VQAE 120 may select questions such as “Was the underlayment installed correctly according to the specified standards?” In another example, the VQAE 120 may select the question, “Are there any visible defects in the installed underlayment?” In various embodiments, the natural language questions 250 may include questions configured to specific requirements for each construction step to be verified. For example, the natural language questions 250 may be predetermined for each job type and may be linked to the work specific rules 240 (e.g., specific code requirements and/or standards).

In some implementations, the VQAE 120 may select additional questions from the natural language questions 250 based on the location rules 245. For example, the selected question may include “Is this image taken at ‘X’?” while the VQAE 120 may replace ‘X’ with a name of the construction site.

In some implementations, the AWID 200 may identify a geolocation associated with images received from the user device 105 to verify whether the received images are taken from the job site (e.g., by matching the location of the job site and to provide a self-check mechanism). In some implementations, the AWID 200 may apply the natural language questions 250, the location rules 245, and the received image to the multimodal LLMs 130 to verify the geolocation associated with the images. For example, the multimodal LLMs 130 determine whether the image is taken at the construction site. In some implementations, the VQAE 120 may be configured to supply additional information to the multimodal LLMs 130 to facilitate more accurate determination. In various examples, the VQAE 120 may supply the location rules 245 to the multimodal LLMs 130. For example, the location rules 245 may include environmental images of the construction site. Based on the environmental images, for example, the multimodal LLMs 130 may determine whether an image is taken at the construction site.

For example, the multimodal LLMs 130 may analyze inputs received from the VQAE 120 to generate responses to the selected questions (e.g., producing the binary classification vector 140). In some examples, the binary classification vector 140 may indicate a received image corresponding to a construction step that complies with the work specific rules 240 (e.g., TRUE for compliant, FALSE for non-compliant). The results, including any justifications for non-compliance, may be received. In some examples, the result and/or the justification may be stored to update the job metadata 235 by the resource management engine 115.

For example, the AWID 200 may generate a notification of any improperly installed component. In some implementations, the notification engine 145 may retrieve the result and the justification to be transmitted to the reviewer device 150 (e.g., in real-time).

The data store 230 includes, in this example, historical records 255 and contractor rankings. For example, the historical records 255 may include records of each contractor (e.g., past performance data, previous job details, compliance history, and/or quality assessment results for various construction projects of each corresponding contractor). For example, the notification engine 145 may retrieve the historical records 255 to generate an overview of each of the construction steps. For example, the notification engine 145 may identify common issues and/or best practices to the reviewer device 150. In some implementations, the natural language questions 250 may be adjusted based on the historical records 255. For example, additional questions or modification of questions may be implemented based on identified issues and/or best practices. The contractor rankings 260, for example, may be generated based on these historical records, evaluating contractors on historical factors (e.g., whether work done adheres to quality standards, timeliness, overall performance, and/or a combination thereof).

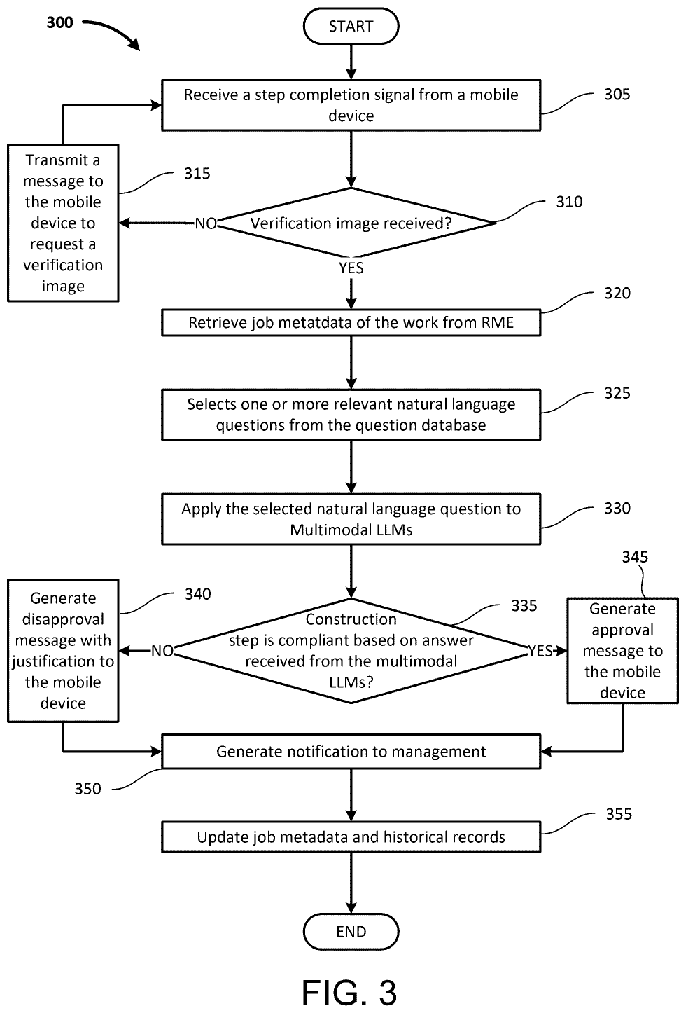

FIG. 3 is a flowchart illustrating an exemplary automatic natural language monitoring method. For example, a method 300 may be performed by the AWID 200 as described with reference to FIG. 2. In this example, the method 300 begins in step 305 when a step completion signal is received from a mobile device. For example, the step completion signal may indicate one stage of a multiple staged job is completed by the worker 110.

At a decision point 310, it is determined whether a verification image has been received. For example, the VQAE 120 may check whether the verification image has been received from the user device 105. In step 315, a message is transmitted to the mobile device to request a verification image if no image has been received, and the step 305 is repeated. For example, the VQAE 120 may send a message to the worker 110's mobile device requesting the required image for verification.

If a verification image is received, in step 320, job metadata of the work is retrieved from a resource management engine (RME). For example, the VQAE 120 may retrieve job metadata 235 from the resource management engine 115 to gather details about the job. In step 325, one or more relevant natural language questions are selected from the question database. For example, the VQAE 120 may select one or more questions from the natural language questions 250 to verify the step completion based on the job metadata 235, the work specific rules 240, and/or the location rules 245.

In step 330, the selected natural language question is applied to the multimodal LLMs. For example, the VQAE 120 may apply the received images, the selected questions, and metadata (e.g., the job metadata 235, the work specific rules 240, and/or the location rules 245) to the multimodal LLMs 130.

At a decision point 335, it is determined whether the construction step is compliant based on an answer received from the multimodal LLMs. For example, the multimodal LLMs 130 may return a natural language answer package (e.g., with answers to multiple questions) to the VQAE 120. In some implementations, the VQAE 120 may evaluate the natural language answer package to determine whether the construction meets required standards (e.g., indicated by the work specific rules 240).

If the construction step is not compliant, in step 340, a disapproval message with justification is generated and sent to the mobile device. For example, the notification engine 145 may send a disapproval message with reasons for non-compliance to the user device 105. If the construction step is compliant, in step 345, an approval message is generated and sent to the mobile device. For example, the notification engine 145 may send an approval notification to the worker 110's mobile device confirming that the step is compliant.

In step 350, after an approval message or a disapproval message is transmitted, a notification is generated and sent to management. For example, the notification engine 145 may notify the relevant management personnel about the compliance status of the construction step. Next, in step 355, job metadata and historical records are updated, and the method 300 ends. For example, the VQAE 120 may update the job metadata 235 with the latest job status and the historical records 255 with reference to historical performance data of the worker 110 (e.g., including the compliance results for the construction step).

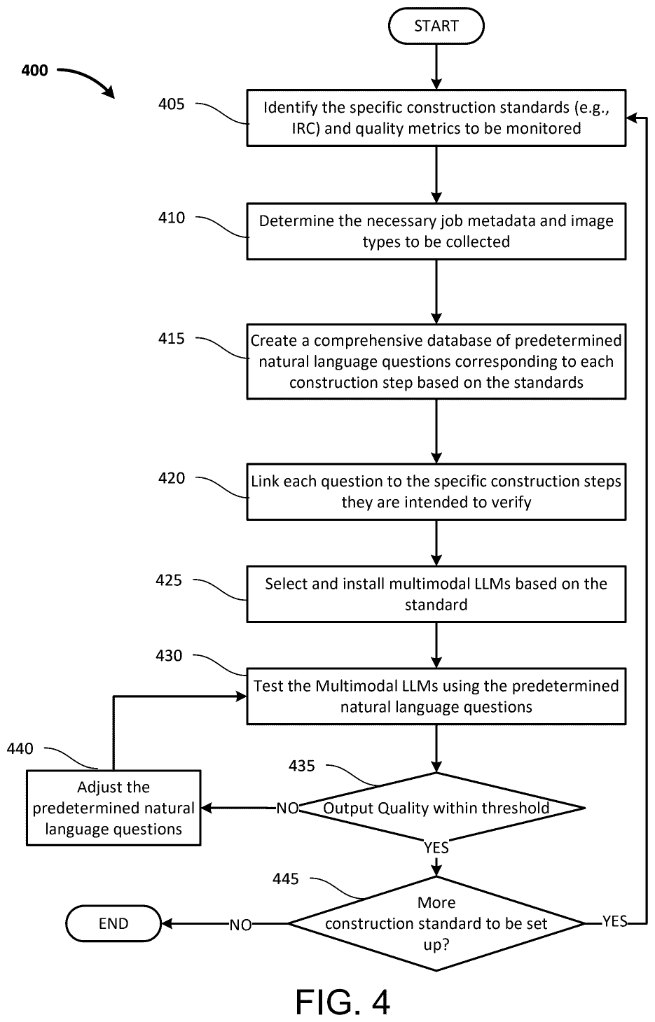

FIG. 4 is a flowchart illustrating an exemplary ANLMS configuration method. For example, a method 400 may be performed when a user is defining a new job and/or work flow in the ANLMS 100 and/or the AWID 200. In this example, the method 400 begins when the specific construction standards and quality metrics to be monitored are identified in step 405. For example, the user may identify the specific construction standards (e.g., IRC) and quality metrics based on a characteristic (e.g., location, job type) of the job.

In step 410, the necessary job metadata and image types to be collected are determined. For example, the user may determine, for each stage of the job (e.g., a removal step, a valley lining step, an underlayment step, a roofing step), required job metadata and images for the construction process. In step 415, a comprehensive database of predetermined natural language questions corresponding to each construction step based on the standards is created. For example, the user may generate the natural language questions 250 configured to verify each construction step of the job.

In step 420, each question is linked to the specific construction steps they are intended to verify. For example, the user may link each question in the natural language questions 250 to its corresponding construction step at the VQAE 120. For example, the VQAE 120 may be configured to select relevant questions based on the job metadata 235, the work specific rules 240, and the location rules 245 from the natural language questions 250 in this step.

In step 425, multimodal LLMs are selected and installed based on the standard. For example, the user may select and install appropriate multimodal LLMs from the multimodal LLMs 130 to process the data according to the identified standards. In step 430, the multimodal LLMs are tested using the predetermined natural language questions. For example, the user may test the installed LLMs with the created questions and/or images to verify their effectiveness (e.g. accuracy, recall).

At a decision point 435, it is determined whether the output quality is within the acceptable threshold. For example, the system may check if the LLMs' outputs meet the required quality standards. If the output quality is not within the threshold, in step 440, the predetermined natural language questions are adjusted, and the step 430 is repeated. For example, the user may adjust the questions to improve the output quality.

If the output quality is within the threshold, at a decision point 445, it is determined whether more construction standards need to be set up. For example, the user may check if additional job types are required for the configuration. If no more construction standards need to be set up, the method 400 ends. If additional standards are required, the method 400 returns to step 405.

Although various embodiments have been described with reference to the figures, other embodiments are possible.

Although an exemplary system has been described with reference to FIG. 1, other implementations may be deployed in other industrial, scientific, medical, commercial, and/or residential applications.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as nominal batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may, for example, include an LCD (liquid crystal display). In some implementations, the display device may, for example, include an OLED (organic light-emitting diode) display. In some implementations, the display device may, for example, include a QLED (quantum dot LED) display. A display device (e.g., monitor) may, for example, be used for displaying information to the user. Some implementations may, for example, include a keyboard and/or pointing device (e.g., mouse, trackpad, trackball, joystick) configured to allow the user to provide input to the computer. Some implementations may include touchscreen technology configured to provide a direct interaction interface with the display device. In some implementations, the display device may, for example, include a 4K or higher resolution display configured to provide high-definition graphical output.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A system comprising:
a data store comprising a program of instructions; and,
a processor operably coupled to the data store such that, when the processor executes the program of instructions, the processor causes operations to be performed to automatically determine compliance with a predetermined quality standard of one or more steps in a construction project, the operations comprising:
receive an input comprising one or more images of a step in a construction project;
retrieve metadata of the construction project from a data store; and,
based on the received one or more images of the step in the construction project and the retrieved metadata, determine whether the step in the construction project complies with a predetermined quality standard by applying one or more predetermined natural language questions to one or more multimodal large language models;
based on the determined compliance of the step in the construction project, generate an output signal indicating whether the step in the construction project meets the predetermined quality standard,
such that compliance with the predetermined quality standard of the step in the construction project is verified.

2. The system of claim 1, wherein the output signal further comprises a binary classification vector indicating whether the step in the construction project meets the predetermined quality standard.

3. The system of claim 2, wherein the operations further comprise:
transmit the binary classification vector indicating whether the step in the construction project meets the predetermined quality standard to a user device.

4. The system of claim 2, wherein the operations further comprise:
transmit the binary classification vector indicating whether the step in the construction project meets the predetermined quality standard to the data store; and,
store the binary classification vector indicating whether the step in the construction project meets the predetermined quality standard in the data store.

5. The system of claim 2, wherein the operations further compromise:
identify one or more deviations from the predetermined quality standard; and,
generate a report that includes the binary classification vector indicating whether the step in the construction project meets the predetermined quality standard and the one or more identified deviations from the predetermined quality standard.

6. The system of claim 1, wherein the metadata comprises geolocation data of the construction project.

7. The system of claim 6, wherein the operations further comprise:
retrieve geolocation data from the one or more images of a step in a construction project to determine a geolocation of where the one or more images of a step in a construction project were captured; and,
based on the geolocation data of the construction project and the geolocation data from the one or more images, verify that the one or more images correspond to the geolocation data of the construction project.

8. The system of claim 1, wherein predetermined quality standard is based on industry codes and regulations.

9. A computer program product (CPP) comprising a program of instructions tangibly embodied on a non-transitory computer readable medium wherein, when the instructions are executed on a processor, the processor causes operations to be performed to automatically determine compliance with a predetermined quality standard of one or more steps in a construction project, the operations comprising:
receive an input comprising one or more images of a step in a construction project;
retrieve metadata of the construction project from a data store; and,
based on the received one or more images of the step in the construction project and the retrieved metadata, determine whether the step in the construction project complies with a predetermined quality standard by applying one or more predetermined natural language questions corresponding to the step in the construction project to one or more multimodal large language models;
based on the determined compliance of the step in the construction project, generate an output signal indicating whether the step in the construction project meets the predetermined quality standard,
such that compliance with the predetermined quality standard of the step in the construction project is verified.

10. The CPP of claim 9, wherein the output signal further comprises a binary classification vector indicating whether the step in the construction project meets the predetermined quality standard.

11. The CPP of claim 10, wherein the operations further comprise:
transmit the binary classification vector indicating whether the step in the construction project meets the predetermined quality standard to a user device.

12. The CPP of claim 10, wherein the operations further comprise:
transmit the binary classification vector indicating whether the step in the construction project meets the predetermined quality standard to the data store; and,
store the binary classification vector indicating whether the step in the construction project meets the predetermined quality standard in the data store.

13. The CPP of claim 10, wherein the operations further compromise:
identify one or more deviations from the predetermined quality standard; and,
generate a report that includes the binary classification vector indicating whether the step in the construction project meets the predetermined quality standard and the one or more identified deviations from the predetermined quality standard.

14. The CPP of claim 9, wherein the metadata further comprises information about the construction project.

15. The CPP of claim 14, wherein the information about the construction project comprises geolocation data of the construction project.

16. The CPP of claim 15, wherein the operations further comprise:
retrieve geolocation data from the one or more images of a step in a construction project to determine a geolocation of where the one or more images of a step in a construction project were captured; and,
based on the geolocation data of the construction project and the geolocation data from the one or more images, verify that the one or more images correspond to the geolocation data of the construction project.

17. The CPP of claim 14, wherein the information about the construction project further comprises a construction project location, a construction project scope, and a description of work to be performed at the construction project.

18. The CPP of claim 10, wherein the predetermined quality standard is based on industry codes and regulations.

19. The CPP of claim 18, wherein the industry codes and the regulations further comprise the International Residential Code (IRC).

20. A method of configuring an automatic natural language monitoring system comprising:
identifying standards and quality metrics relevant to a construction project;
collecting metadata and image types corresponding to the construction project;
creating a comprehensive database of predetermined natural language questions configured to verify one or more steps in the construction project based on a predetermined quality standard;
linking the predetermined natural language questions to one or more corresponding steps in the construction project;
selecting and installing multimodal large language models configured to process data according to the identified standards and quality metrics;
testing the selected and installed multimodal large language models to evaluate if the quality of a multimodal large language models' outputs meets a predetermined acceptable threshold;
adjusting the identified standards and quality metrics based on testing results; and,
finalizing the configuration of the automatic natural language monitoring system when there are no further adjustments to the identified standards and quality metrics to be made.
